(19) United States
(12) Patent Application Publication
(10) Pub. No.: US 2025/0191195 A1
(43) Pub. Date: Jun. 12, 2025

(54) METHOD FOR TRACKING METAL PRODUCTS AND CORRESPONDING APPARATUS AND PLANT

(71) Applicant: DANIELI AUTOMATION S.P.A., BUTTRIO (UD) (IT)

(72) Inventors: Loris BUSOLINI, CIVIDALE DEL FRIULI (UD) (IT); Matteo SANDRI, TAVAGNACCO (UD) (IT)

(21) Appl. No.: 18/845,113

(22) PCT Filed: Mar. 9, 2023
(86) PCT No.: PCT/IT2023/050068

§ 371 Date: Sep. 9, 2024

(30) Foreign Application Priority Data
Mar. 10, 2022 (IT) IT102022000004568

(51) Int. Cl. G06T 7/20; G06V 10/44; G06V 10/74; G06V 10/82; G06V 20/70

(52) U.S. Cl. CPC G06T 7/20; G06V 10/44; G06V 10/761; G06V 10/82; G06V 20/70; G06V 2201/07

(57) ABSTRACT

The invention concerns a method for tracking metal elements (EM) obtained in a process for working metal products (PM) which provides to detect reference images (RI) and subsequent images (I) of the metal elements (EM) and compare them in order to identify a specific metal element (EM). The invention also concerns an apparatus (10) for tracking metal elements (EM) and a plant for working metal products (PM).

### FIELD OF THE INVENTION

The present invention concerns a method for tracking metal products and a corresponding apparatus.

The present invention can be applied in the iron and steel industry, in the production and working of steel, but also of other metals, to track metal products which are generated by continuous casting plants and subsequently used in rolling units or suchlike.

The present invention also concerns a plant for working metal products comprising an apparatus configured to carry out said method for tracking metal products.

### BACKGROUND OF THE INVENTION

It is known that, in the iron and steel sector, semi-products are cast starting from molten metal obtained from melting processes in an electric furnace or blast furnaces, which can then be subjected to further working steps, including for example rolling, which allow to obtain the finished product. The metal products can subsequently be cut to obtain a plurality of semi-worked metal elements.

In the present text, the term “metal products” includes both long products, such as for example bars, round pieces, billets or suchlike, and also flat products such as slabs.

It is important to be able to track the position, inside the metal product, of each individual metal element, in order to correlate the process variables measured during the production steps of the metal product with the final characteristics of the metal elements thus obtained.

When the metal product is cut, the metal elements thus obtained are grouped together and the information relating to their originating position inside the starting metal product is lost.

Known solutions provide to identify each metal element by affixing onto it an identification code of a known type, such as an identification number, a bar code or QR code or suchlike. The code can be applied to a label which can be applied in a known manner to the metal element, or it can be applied in a known manner directly on the metal element, for example by laser working.

These known solutions have the disadvantage that they at least cause a slowdown of the production process and make it more complex and/or even more expensive. Furthermore, it is possible that the identification codes can be lost or damaged.

Furthermore, the processes in question are generally carried out at high temperatures, and therefore both the correct integration of the identification codes on the metal elements and also their subsequent reading and identification are difficult and complex. Affixing the known codes in a known manner often requires a subsequent working step.

Document US 2021/064940 A1 describes a locating system which executes a method for locating a billet, cut to size by using a flame cutter, having one end which, in its upper and lower portion and in its lateral edges, presents characteristic marks of the flame cut.

There is therefore a need to perfect a method for tracking metal products which can overcome at least one of the disadvantages of the state of the art.

In particular, one purpose of the present invention is to perfect a method, and to provide a corresponding apparatus, for recognizing and then tracking the metal elements obtained from a metal product which is simple and reliable.

It is also a purpose of the invention to perfect a method which can be carried out during the normal production steps of the metal elements and does not provide additional working steps which can slow down the production process.

It is also a purpose of the invention to perfect a method which is simple to carry out, during in-line working.

Another purpose of the present invention is to provide an apparatus for tracking metal elements which can also be applied to already existing iron and steel plants.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problems disclosed above in a new and original way, also achieving considerable advantages compared to the state of the prior art, a method has been perfected for tracking metal elements obtained in a process for working metal products according to the present invention comprising a coding step which provides to:
acquire reference images of at least one end of each metal element which is obtained by dividing a specific metal product and associating the originating position of the metal element in the metal product with each reference image;
store the reference images and provide a subsequent step of recognizing the metal elements.

By the term “coding” we mean the association of information on the originating position of the metal element in the metal product with a reference image.

In the event the images of the two ends of the metal element are acquired, the method provides to associate both images with their metal element. The two images of the two ends can possibly be labeled differently, so as to distinguish a head end, that is, the one facing forward in the direction of advance, from a tail end.

The step of recognizing the metal elements provides to:
acquire at least one image of at least one end of one of the metal elements;
compare the at least one acquired image with the reference images which are correlated to the metal product;
associate the at least one acquired image with the respective reference image relating to the same metal element, in order to recognize the metal element and determine its originating position.

In the event only the image of one of the two ends of the metal element is acquired in the coding step, the method provides that the end considered in the recognition step is the same one that was considered in the coding step.

In the event images of both of the two ends of the metal elements are acquired in the coding step, the method can provide that only an image of one of the two ends, or the images of both the ends previously considered, is/are acquired in the recognition step.

Doing so achieves at least the advantage that it is possible to associate the metal elements obtained from a metal product with the position that such metal elements occupied inside the metal product before the cut.

Advantageously, it is possible to track the metal elements that constitute the metal product, without the requirement to monitor the position of each of them and/or to identify them by means of external identification elements during the frequent displacements required by the production process. Moreover, the tracking can be managed automatically and online during working.

In particular, an advantage is that, by detecting images of one end of the metal element corresponding to the cutting zone of the metal product, the morphological characteristics of the cut performed can be detected, which are distinctive of the very cut that corresponds to the metal element.

According to some embodiments, the method can provide to acquire an image for each metal element obtained from the same metal product and compare, on each occasion, each acquired image with each of the reference images relating to the metal product. It can then provide to supply, at output, a similarity score for each pair of images, to gather the similarity scores in a matrix relating to the metal product and to use the matrix to associate the pair of images relating to the same metal element, for example by pairing together the images that have the highest score.

Advantageously, the compared images relate to a finite and limited number of metal elements. This finite and limited number is equal to the number of metal elements which constitute a metal product or, possibly, which constitute a defined and limited number of metal products.

According to some embodiments, the method can provide to assign a virtual label to each reference image, and therefore to the respective metal element. It can therefore provide that, in a subsequent step in which the references to the position that the metal element occupied inside the metal product before the cut have been lost, it is possible to once again associate the virtual label with the respective metal element, upon the recognition of the corresponding subsequent image.

According to some embodiments, the method can provide to perform the recognition step during a procedure for carrying out destructive and/or non-destructive tests, preferably non-destructive, on the metal elements.

In this way, it is possible to track the correlation between the test results, and therefore between the characteristics of each metal element, and the events that occurred during the working of the metal product, such as, for example, any sudden changes in the values assumed by the working parameters, such as for example temperature, engine torque or suchlike.

Some embodiments of the present invention also concern an apparatus for tracking metal elements obtained in a process for working metal products which comprises at least one viewing device and a coding and recognition device.

In accordance with one aspect of the present invention, the at least one viewing device is configured to acquire reference images of at least one end of each metal element obtained from the division of a specific metal product.

Advantageously, the acquisition of the images can be performed without requiring an interruption or a significant slowdown of the working steps, or without providing additional working steps which can slow down the production process.

The coding and recognition device is configured to associate the originating position of the respective metal element in the metal product with each of the reference images, and to receive at least one image of at least one end of one of the metal elements obtained from the metal product.

The coding and recognition device is also configured to compare the at least one acquired image with the reference images correlated to the metal product, and to associate the at least one acquired image with the respective reference image related to the same metal element and determine the originating position of the metal element inside the respective metal product.

The coding and recognition device can comprise computer vision algorithms configured for the comparison of pairs of images and to associate each acquired image with a respective reference image corresponding to a same metal element.

According to some embodiments, the computer vision algorithms can be based on neural networks or, in particular, networks based on Deep Learning techniques.

Advantageously, the analysis by means of neural networks, or in particular networks based on Deep Learning techniques, can increase the robustness of the recognition method, which can become insensitive to slight differences in the areas detected in the images; for example, due to a different orientation of the metal element, different lighting conditions, the onset of oxidative phenomena or slight damage in the morphology of the area caused, for example, by impacts that occurred after the acquisition of the reference images.

According to some embodiments, the computer vision algorithms can comprise Siamese neural networks which allow to optimize the image analysis processes, increasing their effectiveness and decreasing their execution times and computational costs.

According to other embodiments, the computer vision algorithms can be based on classic techniques of extraction of local features of the images, such as the algorithm according to the SIFT (Scale Invariant Feature Transform) method, for example.

According to some embodiments, the apparatus can comprise two viewing devices. The first can be positioned in correspondence with or in proximity to a cutting zone of the metal products, in which it is still possible to assign to each metal element its originating position in the metal product, and is able to acquire the reference images. The second can be positioned in a working zone in correspondence with which the metal elements are substantially disposed grouped together, generally in bundles in the case of long products with small sections, for example bars, or in stacks in the case of flat products, for example slabs, or long products that cannot be grouped into bundles, such as blooms or billets.

Some embodiments of the present invention also concern a plant for working metal products comprising a unit for feeding a metal product, cutting means configured to cut the metal product dividing it into a plurality of metal elements, grouping means for grouping the metal elements and a tracking apparatus according to the invention disposed at least partly in correspondence with or in proximity to the cutting means and configured to execute a method for tracking metal elements.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of an apparatus for tracking metal products according to the present invention;

FIG. 2 is a schematic representation of a plant for working metal products according to the present invention;

FIG. 3 is a schematic representation of a method for tracking metal products according to the present invention;

FIG. 4 is a schematic representation of a step of the method for tracking metal products of FIG. 3;

FIG. 5 is an example representation of a result of the method for tracking metal products of FIG. 3.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

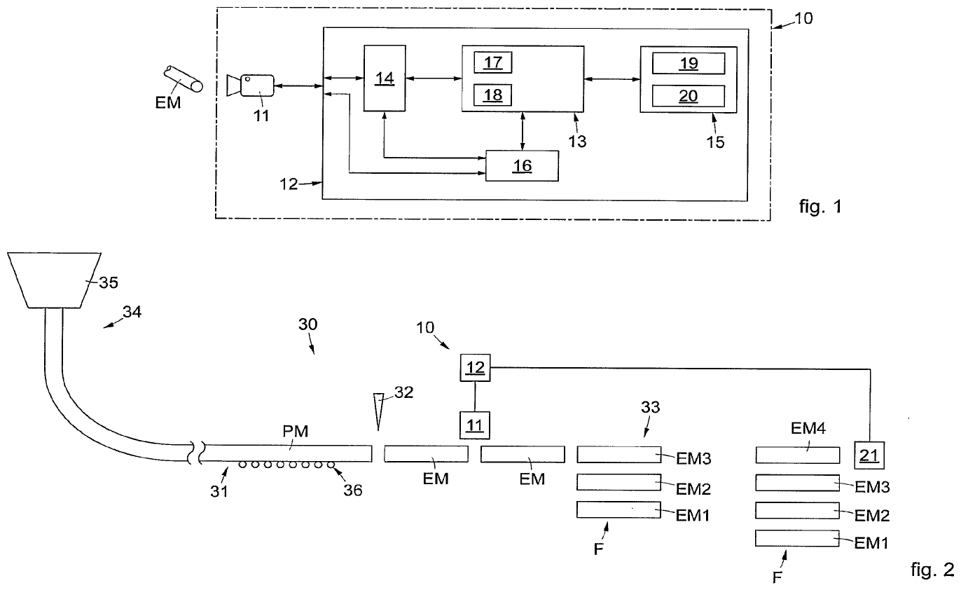

With reference to FIG. 1, some embodiments of the present invention concern a tracking apparatus 10 which can be used in a plant 30 for working metal products PM, for example obtained by continuous casting and subsequent rolling, or suchlike.

In particular, the apparatus 10 can be used for tracking the metal elements EM, such as billets, blooms, round bars, slabs or suchlike, into which an initial metal product PM can be divided.

In the following description, we will refer mainly to long products such as, for example, bars which are normally grouped into bundles F at the end of a certain working; however, the same considerations can also be easily transferred to flat metal products or even to some types of long products, such as billets or blooms for example, which are not grouped into bundles but are normally grouped and stored in stacks in special slab/billet parks.

According to some embodiments, the apparatus 10 can comprise at least one viewing device 11 and a coding and recognition device 12.

The at least one viewing device 11 is able to acquire images and/or videos of a metal element EM; it can be, or comprise, a photo camera, a video camera, or suchlike.

The at least one viewing device 11 is able to acquire images of at least one end of each metal element EM to be used as initial reference images RI.

Each of the reference images RI can be conveniently associated with the originating position of the metal element EM in the initial metal product PM.

The at least one viewing device 11 can also be configured to acquire images I of the at least one end of the metal elements EM during subsequent working steps of the metal elements EM.

According to other embodiments, two viewing devices 11, 21 can be provided, of which a first viewing device 11 can be positioned in correspondence with a working zone in which it is still possible to assign to each metal element EM its position in the metal product PM of origin, for example in an instant immediately following the cut but before the metal elements EM are gathered in a bundle F or in a stack. In particular, it can be able to detect the initial reference images RI.

For example, the first viewing device 11 can be positioned in correspondence with the cutting area of the metal product PM, facing a conveyor belt transporting the metal elements EM from the cutting point to the point where they are gathered in a bundle F of metal elements EM, or suchlike.

The second viewing device 21 can be positioned in a working zone in correspondence with which it is no longer possible to associate each metal element EM with its position in the metal product PM of origin. For example, it can be placed in an area where it is necessary to recognize the individual metal elements EM within the bundle F, such as an area where destructive and/or non-destructive tests are carried out, or suchlike. In particular, it can be able to detect the images I during the subsequent working steps of the metal elements EM, for example during the tests as above.

According to other embodiments, the viewing device(s) 11, 21 can be configured to acquire images of both ends of each metal element EM. In this case, the viewing device(s) 11, 21 can each comprise a mobile photo or video camera, or two photo or video cameras positioned facing each other downstream of the cutting zone, each one facing toward one of the respective ends of the metal element EM.

The viewing device 11 can be connected to the device 12, in wired and/or wireless mode.

The device 12 can be configured to receive the data acquired by the viewing device(s) 11, 21, that is, the images and/or videos, and process them in order to track the metal elements EM.

The device 12 can also be configured to carry out a bijective association between the reference images RI acquired in the proximity of the cutting zone and the originating position of the metal element EM obtained from the division of the metal product PM. The bijective association can be obtained, for example, by assigning a progressive number to each reference image RI acquired corresponding to the position of the metal element EM.

The device 12 can also be configured to receive and process the images I of the metal elements EM acquired in subsequent working zones or steps, in order to reconstruct their originating position.

The device 12 can also be configured to execute computer vision algorithms. The computer vision algorithms can be configured to compare reference images RI of the metal elements EM with images I thereof acquired during a subsequent working step, for example during the non-destructive tests. The computer vision algorithms can be based on Deep Learning techniques and/or neural networks. In particular and in a preferred embodiment, the device 12 can comprise neural networks suitable to perform a classification of the acquired images I on the basis of the stored reference images RI.

According to some embodiments, the device 12 can comprise at least one Siamese neural network SN (Siamese Network) configured to receive pairs of two images I, RI at input and compare them.

The Siamese neural network SN can comprise two sub-networks SR1, SR2 having the same architecture, parameters and weights.

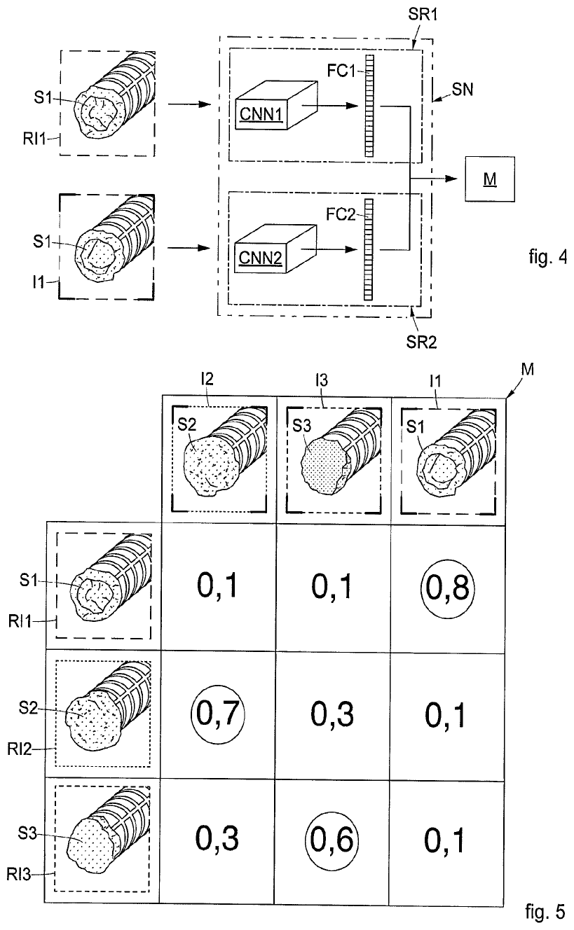

For example, FIG. 4 shows a Siamese network SN comprising two sub-networks SR1, SR2, each having one or more convolutional layers CNN1, CNN2 and a subsequent fully connected layer FC1, FC2.

According to one variant, the computer vision algorithms can be based on traditional matching techniques. By way of a non-exhaustive example, techniques for the extraction of local features of the image can be used, such as the SIFT algorithm and matching algorithms, for example.

According to some embodiments, the computer vision algorithms can be configured to compare reference images RI and subsequent images I of metal elements EM obtained from a same metal product PM and gathered in a same bundle F.

As another example, the computer vision algorithms can be configured to compare reference images RI and subsequent images I of metal elements EM obtained from a set of metal products PM and gathered in the same bundle F.

In particular, it can compare on each occasion a reference image RI and a subsequent I image and produce a similarity score, or evaluation, at output. The similarity scores can be gathered (FIG. 5) in a matrix M relating to a metal product PM and be used to associate, two by two, the images RI, I relating to a same metal element EM.

The images I of the metal elements EM to be recognized and whose respective originating position in a specific metal product PM is to be identified are in any case compared with a finite number of reference images RI correlated to the single metal product PM, or to the set of metal products PM considered.

In this way, it is possible to concentrate the scores in a finite number of combinations, obtaining effective values which allow to easily obtain a bijective association between the images I, RI corresponding to the same metal element EM.

The coding and recognition device 12 can comprise an image processing unit 13. It can also comprise one or more of either an acquisition unit 14, a graphic interface 15 and/or a control unit 16.

The image processing unit 13 can comprise at least one processing unit 17, or CPU, and at least one storage module 18; it can also comprise auxiliary circuits for interfacing with external power supply systems, external data storage systems, subsequent processing systems and suchlike. For example, the auxiliary circuits can include for example at least one of either: cache circuits, power supply circuits, clock circuits, input/output circuitry, subsystems and/or suchlike.

For example, the processing unit 17 can be any form whatsoever of microprocessor, computer processor or suchlike that can be used in the computer field to execute the computer vision algorithms as above.

The storage module 18 can be connected to the unit 17 and it can be one or more memories among those commercially available, such as a random access memory (RAM), a read-only memory (ROM), floppy disc, hard disk, mass memory, or any other form of digital archiving whatsoever, local or remote, possibly an electronic database.

The computer vision algorithms can for example be encoded and stored in the storage module 18. The images RI, I can also be stored in the storage module 18.

According to some embodiments, the device 12 can comprise a training module and a module for using the computer vision algorithms, when based on Deep Learning techniques and/or neural networks. The training module and the module for using the computer vision algorithms can be implemented in the processing unit 17. The data relating to sets for training (Training Set) and validating (Validation Set) the computer vision algorithms can also be stored in the module 18.

In particular, the training and validation sets can comprise pairs of reference images RI of metal elements EM and corresponding subsequent images I.

The acquisition unit 14 can be a hardware and/or software unit for acquiring and conditioning the signals detected by the at least one viewing device 11. For example, it can comprise filtering elements, amplifying elements and/or suchlike.

The graphic interface 15 can comprise a graphics processing unit, a GPU memory, a graphics training module 19 and a graphics usage module 20 for interfacing with an operator during the use of the computer vision algorithms, when these are based on Deep Learning techniques and/or neural networks.

The control unit 16 can be configured to control the at least one viewing device 11 and/or control other devices/apparatuses, external to the apparatus 10, for the management of manufacturing steps, based on the results of the tracking of the metal products PM. For example, once the repeated presence of a certain defect in correspondence with a certain segment of a metal product PM has been recognized, it can command the interruption of the manufacturing process in order to carry out maintenance operations, the automatic modification of working parameters or similar actions.

The control unit 16 can comprise at least one processing unit and a storage module, or use the processing unit 17 and the storage module 18 of the image processing unit 13.

Some embodiments described here also concern a plant 30 for working metal products PM comprising an apparatus 10 according to the invention configured to execute a method for tracking metal products PM.

The working plant 30 comprises a unit 31 for feeding a metal product PM, cutting means 32 configured to cut the metal product PM dividing it into a plurality of metal elements EM and grouping means 33 for grouping the metal elements EM into bundles F or stacks.

As stated above, in fact, the metal elements EM can be grouped into bundles, as for example occurs for bars (long products from a rolling mill), but also grouped, or stored, in stacks in parks, as for example occurs for slabs and billets.

According to one aspect of the invention, the plant 30 comprises at least one tracking apparatus 10 disposed at least partly in correspondence with or in proximity to the cutting means 32 and configured to execute a method for tracking metal elements EM.

In other embodiments, the feed unit 31 can comprise a casting unit 34 comprising a ladle 35 for pouring molten metal and at least one roller conveyor 36 on which a metal product PM can advance.

The ladle 35 and the roller conveyor 36 can be directly connected to each other, or be separate from each other. In the latter case, the metal products PM to be cut can be taken from a warehouse.

As shown in FIG. 2, the plant 30 comprises an apparatus 10 having a first viewing device 11 disposed in proximity to the cutting means 32 and a second viewing device 21 disposed in a position distant therefrom, where the metal elements EM are grouped, by way of example, into bundles F.

The operation of the apparatus 10 for tracking metal products PM described heretofore, which corresponds to the method according to the present invention, can provide at least one coding step which comprises at least part of the following steps:
dividing a metal product PM into a plurality of metal elements EM;
acquiring reference images RI of at least one end of each of the metal elements EM;
associating each reference image RI with the originating position of the respective metal element EM in the metal product PM.

Once the association between reference images RI and position has been made, the metal elements EM obtained from a same metal product PM, or from a set of metal products PM, can be separated, or grouped together, for example in a same bundle F.

The tracking method according to the invention can also comprise at least one recognition step, which provides to:
acquire at least one image I of at least one end of one of the metal elements EM during a subsequent working step, for example after these have been gathered into a bundle F;
compare the at least one acquired image I with the reference images RI of the metal elements EM correlated to one or to a set of metal products PM;
associate the images RI, I relating to a same metal element EM in order to recognize the metal element EM and determine its originating position.

The step of comparing the reference images RI with subsequent images I can provide to use computer vision algorithms.

The comparison can provide to supply pairs of images RI, I at input to the computer vision algorithm, the first image chosen from the set of reference images RI and the second from the set of subsequent images I. The comparison step can provide to use computer vision algorithms based on Deep Learning and neural networks, preferably Siamese neural networks.

The method can provide to detect images of one end of the metal element EM. The end of the metal element EM corresponds to the cutting zone of the metal element PM.

Advantageously, the cut generates a cutting surface S1, S2, S3 which usually has characteristics, or morphology, which are distinctive for each cut; in this way, it is possible to associate a corresponding distinctive cutting surface S1, S2, S3 with each metal element EM. By detecting an image of the cutting surface S1, S2, S3 it is therefore possible to recognize the corresponding metal element EM.

The method can provide to compare reference images RI and subsequent images I of metal elements EM obtained from a same metal product PM and possibly gathered in a same bundle F, or stack.

The method can provide to compare reference images RI and subsequent images I of metal elements EM obtained from a set of metal products PM possibly gathered in a same bundle F, or stack.

In both the above cases, the compared images RI, I relate to a finite and limited number of metal elements EM.

The method can provide that, in a step of classifying the reference images RI, each reference image RI, and therefore the respective metal element EM, is assigned a virtual label. It can then provide that, upon recognition of the subsequent image I, the virtual label is reassigned to the respective metal element EM.

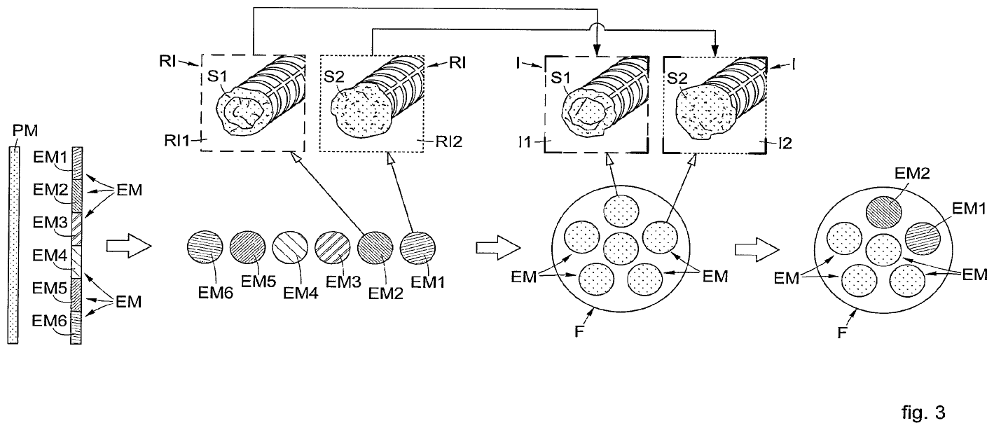

For example and as shown in FIG. 3, a metal product PM is divided into a set of metal elements EM1, EM2, EM3, EM4, EM5, EM6.

After the metal elements EM1, EM2, EM3, EM4, EM5, EM6 have been gathered in the bundle F, the information relating to the position of each single metal element EM1, EM2, EM3, EM4, EM5, EM6 inside the metal product PM is lost.

By means of the comparison as above, the images RI1 and I1 and the images RI2 and I2 are respectively associated with each other. In this way, within the bundle F, it is possible to recognize the elements EM1, EM2.

As an additional example and as shown in FIG. 5, the similarity scores relating to the comparison of images RI1, RI2, RI3 and I1, I2, I3 of respective metal elements EM1, EM2, EM3 are gathered in a matrix M. The recognition can be performed by associating the images RI1, RI2, RI3 and I1, I2, I3 which have the highest scores with each other, which are circled in FIG. 5.

It is clear that modifications and/or additions of parts may be made to the apparatus 10 and to the method as described heretofore, without departing from the field and scope of the present invention, as defined by the claims.

It is also clear that, although the present invention has been described with reference to some specific examples, a person of skill in the art shall be able to achieve other equivalent forms of method for tracking metal products and corresponding apparatus 10, having the characteristics as set forth in the claims and hence all coming within their field of protection.

In the following claims, the sole purpose of the references in brackets is to facilitate their reading and they must not be considered as restrictive factors with regard to the field of protection defined by the same claims.

1. Method for tracking metal elements obtained in a process for working metal products, wherein it comprises a coding step in which:
reference images of at least one end of each of said metal elements obtained from one said metal product are acquired and stored;
each of said images is associated with an originating position of said metal elements in said metal product;
subsequently, a step of recognition of said metal elements is provided, in which at least one image is acquired of the at least one end of one of said metal elements considered in said coding step, which is compared with said reference images in order to then associate it with the one, amongst them, which corresponds to a same metal element, determining its originating position.

2. Method as in claim 1, wherein it provides to acquire said image for each said metal element obtained from the same metal product and compare it with each of said reference images supplying, at output, a similarity score for each pair of images, and in that it provides to gather said similarity scores in a matrix relating to said metal product using said matrix to associate the pair of images relating to a same metal element.

3. Method as in claim 1, wherein it provides to assign a virtual label both to each said reference image and also subsequently, the moment of recognition of each said corresponding image, to the respective metal element.

4. Method as in claim 1, wherein the comparison between said images and said reference images occurs using a neural network of the Siamese type.

5. Method as in claim 1, wherein the comparison between said images and said reference images occurs using computer vision techniques such as algorithms for extracting local features of the image.

6. Method as in claim 1, wherein said images are compared with a finite number of reference images correlated to a single metal product or to a finite set of metal products.

7. Method as in claim 1, wherein it provides to execute said recognition step during a procedure for carrying out destructive and/or non-destructive tests on said metal elements.

8. Apparatus for tracking metal elements obtained in a process for working metal products, wherein it comprises at least one viewing device configured to acquire reference images of at least one end of each of said metal elements and a coding and recognition device configured to associate an originating position of said respective metal elements in said metal product with each of said reference images, to receive at least one image of the at least one end of one of said metal elements considered by said viewing device, to compare said at least one image with said reference images and then associate it with a respective reference image relating to the one of said metal elements and determine its originating position.

9. Apparatus as in claim 8, wherein said coding and recognition device comprises computer vision algorithms configured to compare pairs of images and associate each image with a respective reference image corresponding to a same metal element, wherein said computer vision algorithms are based on neural network techniques, networks based on Deep Learning or on computer vision techniques such as extraction of local features of the image.

10. Apparatus as in claim 9, wherein said computer vision algorithms comprise Siamese neural networks.

11. Apparatus as in claim 8, wherein it comprises two viewing devices, the first being positioned in correspondence with or in proximity to a cutting zone of said metal products in which it is still possible to assign to each said metal element its originating position in said metal product and being able to detect said reference images, and the second being positioned in a working zone in correspondence with which said metal elements are substantially disposed grouped.

12. Plant for working metal products comprising a feed unit, cutting means configured to cut said metal products into a plurality of metal elements, grouping means for grouping said metal elements and a tracking apparatus as in claim 8 disposed at least partly in correspondence with or in proximity to said cutting means and configured to execute a method for tracking metal elements as in claim 1.
